(19) United States
(12) Patent Application Publication
(10) Pub. No.: US 2011/0158453 A1
(43) Pub. Date: Jun. 30, 2011

(54) MICROPHONE UNIT

(75) Inventors: Fuminori TANAKA, Osaka (JP); Ryusuke Horibe, Osaka (JP); Shuji Umeda, Osaka (JP); Takeshi Inoda, Osaka (JP)

(73) Assignee: FUNAI ELECTRIC CO., LTD., Osaka (JP)

(21) Appl. No.: 12/954,810

(22) Filed: Nov. 26, 2010

(30) Foreign Application Priority Data
Nov. 26, 2009 (JP) 2009-268194

(51) Int. Cl. H04R 1/02

(52) U.S. Cl. 381/361; 381/355

(57) ABSTRACT

The microphone unit of the present invention comprises an electro-acoustic converter for converting an acoustic signal to an electric signal, the converter having a diaphragm displaced by acoustic pressure; and a housing provided with an accommodation space for accommodating the electro-acoustic converter, and with an acoustic path for guiding outside sound from an acoustic hole to the diaphragm. An external-connection electrode having the same function is formed on a first external surface belonging to the housing and having the acoustic hole, and on a second external surface on the side opposite the first external surface of the housing.

This application is based on Japanese Patent Application No. 2009-268194 filed on Nov. 26, 2009, the contents of which are hereby incorporated by reference.

### BACKGROUND OF THE INVENTION

1. Field of the Invention

The present invention relates to a microphone unit having the function of converting input sound to an electric signal and outputting the signal.

2. Description of Related Art

Microphone units are used in voice input apparatuses, including portable telephones, transceivers, and other types of voice communications equipment; information processing systems that employ technology for analyzing a voice input to a voice recognition system; and recording equipment (refer to Patent Document 1). In a case in which a microphone unit is used in a voice input unit, the microphone unit can be mounted on the top or bottom surface of a mounting substrate of the voice input unit (refer to Patent Document 2).

FIG. 11 is a cross sectional view of an example of a conventional configuration in a case in which the microphone unit is mounted on the top surface of the mounting substrate. In the configuration shown in FIG. 11, a microphone unit 100 is interposed between a case top part 201 and a mounting substrate 301 of a voice input unit 200. An acoustic hole 102 is provided to the top surface of a housing 101 of the microphone unit 100 so as to face an introduction hole 202 formed in the case top part 201 of the voice input unit 200. An external-connection electrode 103, which is electrically connected to a connection pad 302 formed on the top surface of the mounting substrate 301, is formed on the bottom surface of the housing 101 of the microphone unit 100. Symbol 104 is an electro-acoustic converter for converting an acoustic signal to an electric signal, and the converter has a diaphragm 104a displaced by acoustic pressure (the same applies to FIG. 12 below).

FIG. 12 is a cross-sectional view showing an example of a conventional configuration in a case in which the microphone unit is mounted on the bottom surface of the mounting substrate. In the configuration shown in FIG. 12, the mounting substrate 301 is interposed between the case top part 201 of the voice input unit 200 and the microphone unit 100. A through-hole 303 is provided to the mounting substrate 301 so as to face an introduction hole 202 formed in the case top part 201 of the voice input unit 200. The top surface of the housing 101 of the microphone unit 100 has an acoustic hole 102, which is formed so as to face the through-hole 303, and an external-connection electrode 103, which is electrically connected to a connection pad 302 formed on the bottom surface of the mounting substrate 301. A gasket 401 for preventing acoustic leakage is disposed between the mounting substrate 301 and the microphone unit 100.
[Patent Document 1] JP-A-2009-135777
[Patent Document 2] JP-A-2008-67173

### SUMMARY OF THE INVENTION

However, when a microphone unit configured to be mounted on the top surface of a mounting substrate, and a microphone unit configured to be mounted on the bottom surface of a mounting substrate are separately produced as different products, as in the conventional art, there is an increase in the burden imposed in terms of work, product management, and the like. As a result, there is a problem with the high cost of producing a microphone unit.

In light of the above-mentioned problem, an object of the present invention is to provide a microphone unit that has excellent utility and is intended to reduce manufacturing costs.

In order to accomplish the above-mentioned object, the microphone unit of the present invention comprises an electro-acoustic converter for converting an acoustic signal to an electric signal, the converter having a diaphragm displaced by acoustic pressure; and a housing provided with an accommodation space for accommodating the electro-acoustic converter, and with an acoustic path for guiding outside sound from an acoustic hole to the diaphragm; wherein an external-connection electrode having the same function is formed on a first external surface belonging to the housing and having the acoustic hole, and on a second external surface on the side opposite the first external surface of the housing. The external-connection electrode preferably is configured so as to be used for connection to the connection terminal of a mounting substrate on which the microphone unit is mounted.

According to the present configuration, an external-connection electrode having the same function is formed on both external surfaces that serve as the front and back surfaces of the housing of the microphone unit in relationship to one another. Therefore, a microphone unit thus configured can be mounted on the top or bottom surface of the mounting substrate. Specifically, it is possible to reduce the cost of producing the microphone unit because a microphone unit that is equivalent to two different types of microphone units is produced by producing a single type of microphone unit.

The housing of the microphone unit thus configured has a substrate for mounting the electro-acoustic converter and a cover for covering the substrate to form the accommodation space, the cover having the acoustic hole; the first external surface is a back surface on the side of the cover facing the substrate; and the second external surface is the back surface on the side of the substrate covered by the cover.

According to the present configuration, the external-connection electrode having the same function is formed in the separate members (cover and substrate) constituting the housing. An advantage is obtained in this case because, for example, the configuration of only one element selected from the cover and the substrate can be redesigned rather than modifying the configuration of the entire housing in a case in which it is necessary to modify the electrode arrangement on one side only when the electrode is to be mounted on the top or bottom surface of the mounting substrate.

In the microphone unit thus configured, the acoustic hole includes a first acoustic hole and a second acoustic hole; the housing includes a substrate for mounting the electro-acoustic converter, a cover having a first space communicating with the first acoustic hole and a second space communicating with the second acoustic hole, the cover covering the substrate so that the first space forms the accommodation space, and also includes a groove-forming member disposed on a side of the substrate opposite the side where the cover is disposed, the member forming a groove; the substrate has a first through-hole provided so as to face the diaphragm and a second through-hole provided separately from the first through-hole; the acoustic path includes a first acoustic path leading from the first acoustic hole to one surface of the diaphragm via the accommodation space, and a second acoustic path leading from the second acoustic hole to the other surface of the diaphragm via the second space, the second through-hole, the groove, and the first through-hole in succession; the first external surface is a back surface on the side of the cover facing the substrate; and the second external surface is a back surface on the side of the groove-forming member facing the substrate.

According to this configuration, an effect is achieved of producing a microphone unit that is equivalent to two different types of microphone units by producing a single type of microphone unit as a differential microphone for converting an acoustic signal to an electric signal on the basis of a difference in acoustic pressure applied to both surfaces of a diaphragm. The differential microphone thus configured is capable of eliminating background noise from a sound source remote from the microphone unit, and selectively obtaining a voice produced near the microphone unit. Specifically, the present configuration has an advantage in that a high-performance microphone unit can be produced at a low cost.

The cover and the substrate of a microphone unit thus configured are preferably formed from the same material. According to the present configuration, it is possible to avoid situations in which unnecessary stress is applied to the electro-acoustic converter due to a difference in the thermal expansion coefficient between the cover and substrate in cases in which the microphone unit is reflow mounted to the mounting substrate of a voice input unit. In addition, the external-connection electrode can be easily formed on the cover by forming the cover using the same material as the substrate, such as FR-4.

In the microphone unit thus configured, a solderable junction part is formed so as to enclose the acoustic hole in the first external surface.

According to this configuration, acoustic leakage can be prevented and production is simplified without disposing a gasket between the mounting substrate and the microphone unit in cases in which the microphone unit is disposed on the bottom surface of the mounting substrate. It is of course possible to use a gasket in place of the junction part.

In the microphone unit thus configured, the microphone unit comprises a disconnector for interrupting an electrical connection of the external-connection electrode on the unused side.

According to this configuration, situations in which the external-connection electrode on the unused side comes into contact with other parts inside the voice input apparatus and creates a short circuit can be avoided in cases in which the microphone unit is mounted in a portable telephone or other voice input apparatus. According to this configuration, for example, it is also possible to avoid situations in which static electricity enters the external-connection electrode on the unused side and damages the internal circuit of the microphone unit.

According to this invention, it is possible to provide a microphone unit that has excellent utility and is intended to reduce production costs.

### BRIEF DESCRIPTION OF THE DRAWINGS

FIG. 1A is a schematic perspective view, that is, an oblique upward view, showing the external configuration of the microphone unit according to the present embodiment;

FIG. 1B is a schematic perspective view, that is, an oblique downward view, showing the external configuration of the microphone unit according to the present embodiment;

FIG. 2 is a schematic cross-sectional view at position A-A in FIG. 1A;

FIG. 3 is an exploded oblique view showing the configuration of the microphone unit according to the present embodiment;

FIG. 4 is a schematic plan view showing the configuration of an MEMS (Micro Electro Mechanical System) chip provided to the microphone unit of the present embodiment;

FIG. 5 is a schematic plan view from a downward perspective of the microphone substrate provided to the microphone unit of the present embodiment;

FIG. 6 is a schematic plan view from a downward perspective of the groove-forming member provided to the microphone unit of the present embodiment;

FIG. 7 is a schematic plan view from an upward perspective of the cover provided to the microphone unit of the present embodiment;

FIG. 8A is a schematic cross-sectional view showing a configuration example in a case in which the microphone unit of the present embodiment is mounted on the mounting substrate of a voice input apparatus, that is, in a case in which the microphone unit is mounted on the top surface of the mounting substrate;

FIG. 8B is a schematic cross-sectional view showing a configuration example in a case in which the microphone unit of the present embodiment is mounted on the mounting substrate of a voice input apparatus, that is, in a case in which the microphone unit is mounted on the bottom surface of the mounting substrate;

FIG. 9 is a schematic cross-sectional view showing another embodiment of the microphone unit to which the present invention is applied;

FIG. 10A is a view showing a modified example of the microphone unit according to the present embodiment, that is, a schematic plan view from a downward perspective of a microphone unit provided with a disconnector;

FIG. 10B is a view showing a modified example of the microphone unit according to the present embodiment, that is, a schematic plan view from an upward perspective of a microphone unit provided with a disconnector;

FIG. 11 is a cross-sectional view showing an example of a conventional configuration in a case in which the microphone unit is mounted on the top surface of the mounting substrate; and

FIG. 12 is a cross-sectional view showing an example of a conventional configuration in a case in which the microphone unit is mounted on the bottom surface of the mounting substrate.

### DETAILED DESCRIPTION OF PREFERRED EMBODIMENTS

Embodiments of the microphone unit to which the present invention has been applied will now be described in detail while referring to the drawings.

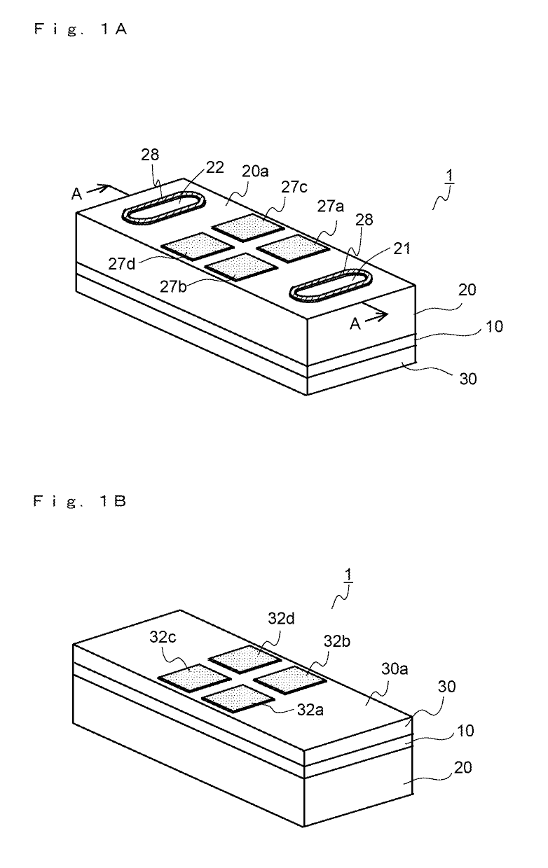

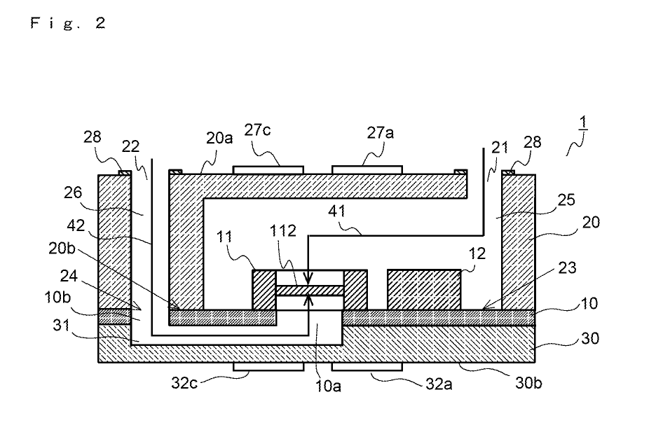

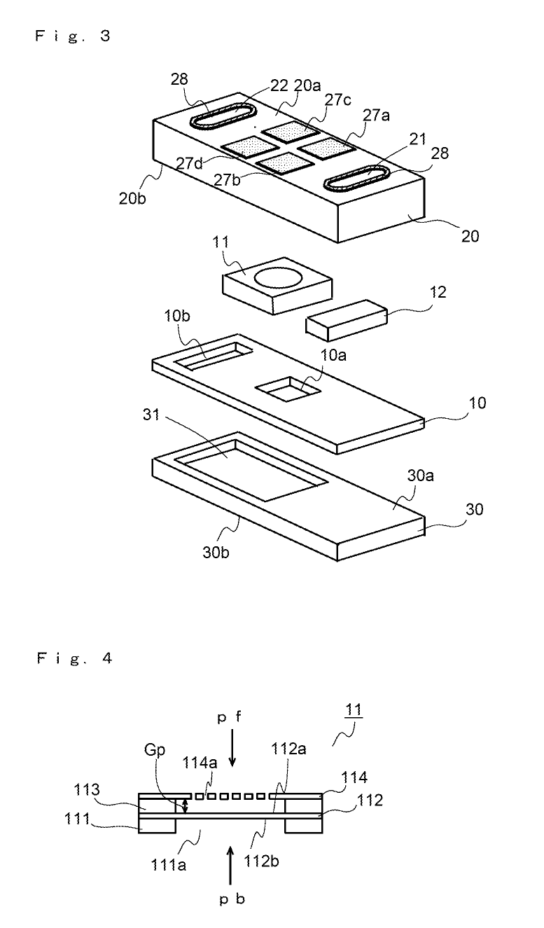

The schematic configuration of the microphone unit according to the present embodiment will first be described while referring to FIGS. 1A, 1B, 2, 3, and 4. FIGS. 1A and 1B are schematic perspective views showing the external configuration of the microphone unit according to the present embodiment. FIG. 1A is an oblique upward view, and FIG. 1B is an oblique downward view. FIG. 2 is a schematic cross-sectional view at position A-A in FIG. 1A. FIG. 3 is an exploded oblique view showing the configuration of the microphone unit according to the present embodiment. FIG. 4 is a schematic plan view showing the configuration of an MEMS (Micro Electro Mechanical System) chip provided to the microphone unit of the present embodiment.

As shown in FIG. 1, a microphone unit 1 of the present embodiment is generally configured so as to have a microphone substrate 10, a cover 20 for covering the top surface of the microphone substrate 10, and a groove-forming member 30 for forming a groove (not shown in FIG. 1), the groove-forming member being disposed at the bottom of the microphone substrate 10.

As shown in FIGS. 2 and 3, a first through-hole 10a formed in an approximately square shape in plan view, and a second through-hole 10b formed in an approximately oblong shape in plan view, are formed on the microphone substrate 10 formed in an approximately rectangular shape in plan view. There are no particular restrictions to the material from which the microphone substrate 10 is formed, but a material commonly known as a substrate material can be used. Examples of such a material include FR-4 and the like.

An MEMS chip 11 is mounted on the top surface of the microphone substrate 10 so as to cover the first through-hole 10a. The MEMS chip 11 has a diaphragm 112 that is displaced by acoustic pressure as shown in FIG. 2, and is an embodiment of the electro-acoustic converter for converting an acoustic signal to an electric signal according to the present invention.

As shown in FIG. 4, the MEMS chip 11 formed from a silicon chip has an insulating base substrate 111, a diaphragm 112, an insulating layer 113, and a fixed electrode 114, and forms a capacitive microphone. An opening 111a substantially round in plan view is formed on the base substrate 111. The diaphragm 112 provided on the base substrate 111 is a thin film for receiving acoustic pressure and vibrating (in the vertical direction), has electric conductivity, and forms one end of an electrode. The fixed electrode 114 is disposed so as to face the diaphragm 112 via the insulating layer 113. Capacitance is thereby formed between the diaphragm 112 and the fixed electrode 114. A plurality of acoustic holes 114a is formed on the fixed electrode 114 so as to allow the passage of acoustic waves and to allow acoustic waves coming from the top of the diaphragm 112 to reach a top surface 112a of the diaphragm 112.

The MEMS chip 11 is thus configured so that acoustic pressure is applied from the top surface 112a and the bottom surface 112b of the diaphragm 112. Therefore, the diaphragm 112 vibrates in accordance with the difference between an acoustic pressure pf applied from the top surface 112a and an acoustic pressure pb applied from the bottom surface 112b. Vibration of the diaphragm 112 causes an interval Gp between the diaphragm 112 and the fixed electrode 114 to vary, and the electrostatic capacitance between the diaphragm 112 and the fixed electrode 114 to vary as well. As a result, an acoustic wave (acoustic signal) incident on the MEMS chip 11 is brought out as an electric signal.

The configuration of the MEMS chip as an electro-acoustic converter is not restricted to the configuration of the present embodiment. For example, the diaphragm 112 is disposed underneath the fixed electrode 114 in the present embodiment, but a configuration having an opposite relationship (a relationship wherein the diaphragm is at the top, and the fixed electrode is at the bottom) may also be adopted.

As shown in FIGS. 2 and 3, an ASIC (Application Specific Integrated Circuit) 12 is mounted transversely to the MEMS chip 11 on the top surface of the microphone substrate 10. The ASIC 12 is an integrated circuit for amplifying the electric signal brought out based on the variation in the electrostatic capacitance of the MEMS chip 11. The ASIC 12 functioning as the signal processor may be configured to include a charge pump circuit and an operational amplifier so that a change in electrostatic capacitance in the MEMS chip 11 can be accurately obtained. The electric signal amplified by the ASIC 12 is output to the outside of the microphone unit 1 by the wiring configuration described below.

The MEMS chip 11 and the ASIC 12 in the microphone unit 1 of the present embodiment are flip-chip mounted on the microphone substrate 10. However, this arrangement is not necessarily restricted to this configuration alone, and can of course be modified such that the MEMS chip 11 and the ASIC 12 are mounted on the microphone substrate 10 by wire bonding.

As shown in FIGS. 1 through 3, the cover 20 is provided so that the exterior shape is approximately a rectangular parallelepiped, and has two openings 21 and 22 in the top surface 20a and two openings 23 and 24 in the bottom surface 20b. In addition, the cover 20 is provided with a first space 25 for joining the first opening 21 of the top surface 20a and the third opening 23 of the bottom surface 20b, and a second space 26 for joining the second opening 22 of the top surface 20a and the fourth opening 24 of the bottom surface 20b. Covering the microphone substrate 10 with the cover 20 allows first space 25 to form an accommodating space for accommodating the MEMS chip 11 and the ASIC 12. In addition, the cover 20 is disposed so that the second space 26 communicates with the second through-hole 10b of the microphone substrate 10.

The openings 21 and 22 in the top surface 20a of the cover 20 are acoustic holes for guiding an outside sound to the diaphragm 112 of the MEMS chip 11. In the description that follows, the first opening 21 is represented as a first acoustic hole 21, and the second opening 22 is represented to as a second acoustic hole 22.

Four external-connection electrodes 27a, 27b, 27c and 27d are provided at the top surface 20a (back surface on the side of the cover 20 facing the microphone substrate 20) of the cover 20. The four external-connection electrodes 27a through 27d are electrodes used for connection to the connection terminals of the mounting substrate on which the microphone unit 1 is mounted. Specifically, the external-connection electrode 27a is an electrode for supplying electric power to the ASIC 12. The external-connection electrode 27b is the electrode for outputting an electric signal from the ASIC 12. The external-connection electrodes 27c and 27d are electrodes for a grounded (GND) connection. Each of the external-connection electrodes 27a through 27d is joined to a wiring formed on the microphone substrate 10. This wiring configuration is described in detail below.

A solderable solder junction part 28 is formed so as to enclose the peripheries of the first acoustic hole 21 and the second acoustic hole 22 in the top surface 20a of the cover 20. This solder junction part 28 may be formed from the same material as used for the external-connection electrodes 27a through 27d, or another material may be used. The same material is convenient in terms of work involved in assembling the microphone unit. This solder junction part 28 is provided in order to prevent acoustic leakage, as described below.

The material that forms the cover 20 can also be an LCP (Liquid Crystal Polymer), PPS (polyphenylene sulfide), or other resin, and can be the same substrate material as that used for the microphone substrate 10, such as FR-4, for example. In the microphone unit 1 of the present embodiment, the same substrate material (for example, FR-4 or the like) as that used for the microphone substrate 10 is preferably used in order to form the electrodes and wiring on the cover 20. The electrodes and wiring can be formed by insert molding in cases in which the cover 20 is formed from LCP or another resin.

Forming the cover 20 from the same material as that used for the microphone substrate 10 is preferred because the following effects are obtained in this case. Specifically, when the cover and substrate are formed from the same material, it is possible to avoid situations in which unnecessary stress is applied to the MEMS chip 11 mounted on the microphone substrate 10 due to a difference in the thermal expansion coefficient between the cover and substrate in cases in which the microphone unit 1 is reflow mounted.

As shown in FIGS. 1 through 3, the groove-forming member 30 is a plate-shaped member having an approximately rectangular shape in plan view, and a groove 31 having an approximately rectangular shape in plan view is formed in the top surface 30a of the member. The groove-forming member 30 is disposed so that the groove 31 communicates with the first through-hole 10a and the second through-hole 10b provided to the microphone substrate 10.

Four external-connection electrodes 32a, 32b, 32c, and 32d are provided to a bottom surface 30b (a back surface on the side of the groove-forming member 30 facing the microphone substrate 10) of the groove-forming member 30. These four external-connection electrodes 32a through 32d are electrodes used for connection to the connection terminals of the mounting substrate on which he microphone unit 1 is mounted, and are electrodes having the same function as the external-connection electrodes 27a through 27d formed on the top surface 20a of the cover 20. Specifically, the external-connection electrode 32a is an electrode for supplying electric power to the ASIC 12; the external-connection electrode 32b is an electrode for outputting an electric signal from the ASIC 12; and the external-connection electrodes 32c and 32d are electrodes for a grounded (GND) connection. Each of the four external-connection electrodes 32a through 32d is joined to wiring formed on the microphone substrate 10. The details of the wiring configuration are described below.

The material that forms the groove-forming member 30 can, for example, be LCP, PPS, or another resin, and can, for example, the same substrate material as that of the microphone substrate 10, such as FR-4. In the microphone unit 1 of the present embodiment, the groove-forming member 30 is formed from the same material as the microphone substrate 10. Therefore, in the microphone unit 1 of the present embodiment, the microphone substrate 10 and groove-forming member 30 can be collectively regarded as a single microphone substrate (in cases in which they are so regarded, the external-connection electrodes 32a and 32b can also be considered as being formed on a back surface of the side of the microphone substrate 10 covered by the cover 20). The same effect as the case in which the cover 20 and the microphone substrate 10 are formed from the same material can be obtained by forming the microphone substrate 10 and the groove-forming member 30 from the same material, as in the present embodiment.

The groove-forming member 30 is a flat plate in the present embodiment, but is not necessarily restricted to this configuration. Specifically, it is possible to adopt a box shape or other configuration having an accommodating convex part for accommodating the microphone substrate 10 and the cover 20, for example. Configuring the groove-forming member in this manner makes it easier to position the microphone substrate 10 and the cover 20 and to assemble the microphone unit 1. The groove-forming member 30 may also be obtained by machining a single member or bonding a plurality of members together, for example.

The microphone substrate 10, cover 20, and groove-forming member 30 are bonded together using, for example, an adhesive or the like to obtain a housing provided with an accommodating space for accommodating the MEMS chip 11 and the ASIC 12, as well as acoustic paths 41 and 42 for guiding outside sound from the acoustic holes 21 and 22 to the diaphragm 112, as shown in FIG. 2.

The first acoustic path 41 is an acoustic path leading from the first acoustic hole 21 to the top surface 112a of the diaphragm 112 via the first space (accommodating space) 25 for accommodating the MEMS chip 11 and the ASIC 12. The second acoustic path 42 is an acoustic path leading from the second acoustic hole 22 to the bottom surface 112b of the diaphragm 112 via the second space 26, the second through-hole 10b, the groove 31, and the first through-hole 10a, in succession. The entire bottom surface of the base substrate 111 of the MEMS chip 11 mounted on the microphone substrate 10 (refer to FIG. 4) fits closely to the microphone substrate 10 so that there is no acoustic leakage from the accommodating space 25 to the bottom surface 112b of the diaphragm 112.

In addition, the top surface 20a of the cover 20 corresponds to an embodiment of the first external surface in the present invention. Furthermore, the bottom surface 30b of the groove-forming member 30 corresponds to an embodiment of the second external surface in the present invention.

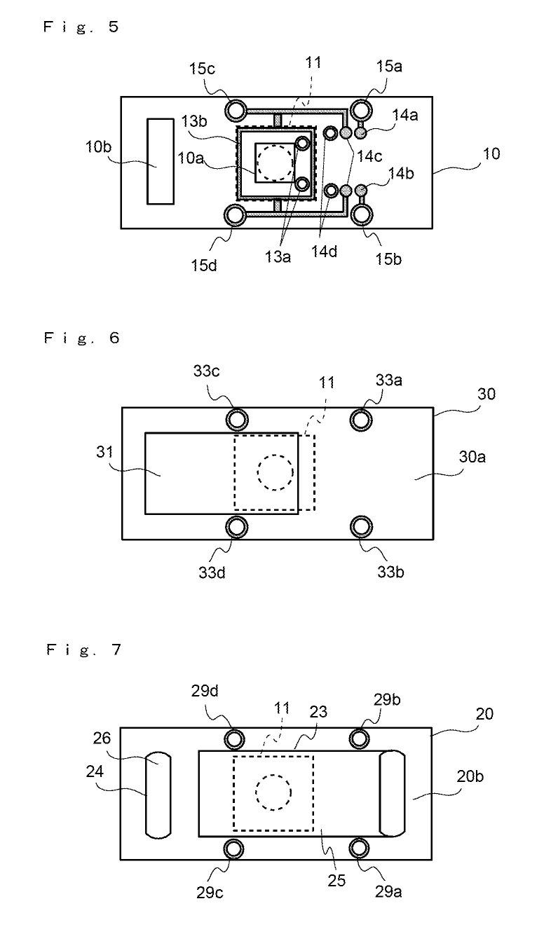

The wiring configuration formed in the microphone unit 1 will now be described while referring to FIGS. 5 through 7. FIG. 5 is a schematic plan view from a downward perspective of the microphone substrate provided to the microphone unit of the present embodiment. FIG. 6 is a schematic plan view from a downward perspective of the groove-forming member provided to the microphone unit of the present embodiment. FIG. 7 is a schematic plan view from an upward perspective of the cover provided to the microphone unit of the present embodiment. In FIGS. 5 through 7, the MEMS chip 11 is shown by a broken line so that the positional correlation with the MEMS chip 11 can be easily understood.

As shown in FIG. 5, a pair of output pads 13a for bringing out an electric signal generated by the MEMS chip 11, and a frame-shaped ground-connection pad 13b used to join the MEMS chip 11 to the microphone substrate 10 and to provide a connection to the ground are formed on the top surface of the microphone substrate 10. A source electric power input pad 14a for inputting source electric power to the ASIC 12, an output pad 14b for outputting a signal processed by the ASIC 12, two GND connection pads 14c for connecting the ASIC 12 to the ground, and a pair of input pads 14d for inputting a signal from the MEMS chip 11 to the ASIC 12 are formed on the top surface of the microphone substrate 10.

An electricity source relay pad 15a electrically connected to the source electric power input pad 14a for inputting source electric power to ASIC 12, a signal output relay pad 15b electrically connected to the output pad 14b for outputting a signal processed by the ASIC 12, and GND relay pads 15c and 15d electrically connected to the GND connection pads 13b and 14c of the MSMS chip 11 and the ASIC 12 are formed on the top surface of the microphone substrate 10.

The output pads 13a and the input pads 14d formed on the top surface of the microphone substrate 10 are electrically connected by internal wiring (not shown) formed inside the microphone substrate 10. A relay pad electrically connected by through-wiring to each of the relay pads 15a through 15d formed on the top surface of microphone substrate 10 is formed on the bottom surface of the microphone substrate 10.

Referring to FIG. 6, an electricity source relay pad 33a electrically connected to the electricity source relay pad 15a formed on the microphone substrate 10 is formed on the top surface 30a of the groove-forming member 30 in a state in which the microphone substrate 10 and groove-forming member 30 are joined to each other. Similarly, the top surface 30a of the groove-forming member 30 is provided with a signal output relay pad 33 electrically connected to the signal output relay pad 15b formed on the microphone substrate 10, and with GND relay pads 33c and 33d electrically connected to the GND relay pads 15c and 15d formed on the microphone substrate 10.

Each of the relay pads 33a through 33d formed on the top surface 30a of the groove-forming member 30 is electrically connected to the respective external-connection electrodes 32a through 32d formed on the bottom surface 30b of the groove-forming member 30 via a through-wiring formed in the groove forming member 30. Specifically, the electricity source relay pad 33a is connected to the external-connection electrode 32a, the signal output relay pad 33b is connected to the external-connection electrode 32b, the GND relay pad 33c is connected to the external-connection electrode 32c, and the GND relay pad 33d is connected to the external-connection electrode 32d.

Referring to FIG. 7, an electricity source relay pad 29a electrically connected to the electricity source relay pad 15a formed on microphone substrate 10 is formed on the bottom surface 20b of the cover 20 in a state in which the microphone substrate 10 is covered (joined) by the cover 20. Similarly, the bottom surface 20b of the cover 20 is provided with a signal output relay pad 29b electrically connected to the signal output relay pad 15b formed on the microphone substrate 10, and with GND relay pads 29c and 29d electrically connected to the GND relay pads 15c and 15d formed on the microphone substrate 10.

Each of the relay pads 29a through 29d formed on the bottom surface 20b of the cover 20 is electrically connected to the respective external-connection electrodes 27a through 27d formed on the top surface 20a of the cover 20 via a through-wiring formed in the cover 20. Specifically, the electricity source relay pad 29a is connected to the external-connection electrode 27a, the signal output relay pad 29b is connected to the external-connection electrode 27b, the GND relay pad 29c is connected to the external-connection electrode 27c, and the GND relay pad 29d is connected to the external-connection electrode 27d.

As described above, the microphone unit 1 is configured so that an external-connection electrode having the same function is formed on the top surface 20a of the cover 20 (first external surface of the housing) and the bottom surface 30b of the groove-forming member 30 (second external surface of the housing). Therefore, the microphone unit 1 can be adapted to be mounted on the top surface of the mounting substrate of a voice input apparatus, or on the bottom surface of the mounting substrate. Specifically, the cost of producing a microphone unit can be reduced because a microphone unit that is equivalent to two different types of microphone units is produced by producing the microphone unit 1 of the present embodiment.

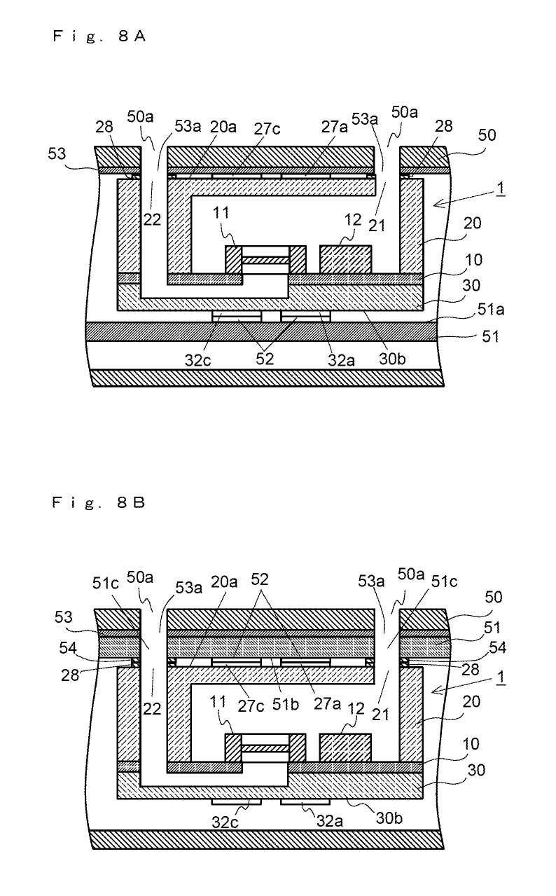

Here, an example of the configuration in a case in which the microphone unit 1 of the present embodiment is mounted on the top surface and on the bottom surface of the mounting substrate of a voice input apparatus will be described while referring to FIGS. 8A and 8B. FIGS. 8A and 8B are schematic cross-sectional views showing examples of configurations in cases in which the microphone unit of the present embodiment is mounted on the mounting substrate of a voice input apparatus. FIG. 8A is a view of a case in which the microphone unit is mounted on the top surface of the mounting substrate, and FIG. 8B is a view of a case in which the microphone unit is mounted on the bottom surface of the mounting substrate.

In the case in which the microphone unit 1 is mounted on the top surface 51a of the mounting substrate 51 of the voice input apparatus (the case in FIG. 8A), each of the external-connection electrodes 32a through 32d provided to the bottom surface 30b of the groove-forming member 30 of the microphone unit 1 is electrically connected using solder or the like to a connection terminal 52 provided to the top surface 51a of the mounting substrate 51.

In this configuration, each of the two acoustic holes 21 and 22 of the microphone unit 1 is disposed so as to communicate with an introduction hole 50a in a case top part 50 of a voice input apparatus. In addition, an elastic body 53 having two through-holes 53a is disposed between the case top part 50 of the voice input apparatus and the microphone unit 1 in order to prevent acoustic leakage, to minimize transmission of vibrations in the casing of the voice input apparatus to the microphone unit 1, and the like. In this configuration, contact against the insulating elastic body 53 can merely be maintained without using the solder junction part 28 and the external-connection electrodes 27a through 27d provided to the top surface 20a of the cover 20 of the microphone unit 1.

In a case in which the microphone unit 1 is mounted on the bottom surface 51b of the mounting substrate 51 of a voice input apparatus (the case in FIG. 8B), each of the external-connection electrodes 27a through 27d provided in the top surface 20a of the cover 20 of the microphone unit 1 is electrically connected using solder or the like to the connection terminal 52 provided to the bottom surface 51a of the mounting substrate 51. In addition, the solder junction part 28 provided to the top surface 20a of the cover 20 of the microphone unit 1 is electrically connected using solder to a connection pad 54 provided to the bottom surface 51a of the mounting substrate 51. The solder connection between the solder junction part 28 and the connection pad 54 prevents acoustic leakage through a space formed between the mounting substrate 51 and the microphone unit 1.

In addition, the two acoustic holes 21 and 22 of the microphone unit 1 in the configuration of FIG. 8B each communicate with a through-hole 51c provided to the mounting substrate 51. The through hole 51c communicates with the through-hole 53a in the elastic body 53 provided to the top side of the mounting substrate 51, and the through-hole 53a of the elastic body 53 communicates with the introduction hole 50a in the case top part 50 of the voice input apparatus. The two acoustic holes 21 and 22 of the microphone unit 1 are thereby each made to communicate with the outside.

The elastic body 53 is disposed in this manner for a reason similar to that followed in the case of FIG. 8A. This configuration dispenses with the external-connection electrodes 32a through 32d provided to the bottom surface 30b of the groove-forming member 30 of the microphone unit 1.

The microphone unit 1 described above shows an example of an embodiment of the present invention, but the application range of the present invention is not limited to the above-described embodiment. Specifically, various modifications to the embodiment described above are acceptable within a range that does not depart from the object of the present invention.

For example, the number of external-connection electrodes 27a through 27d and 32a through 32d in the microphone unit 1 described above is merely an example, and the number of external-connection electrodes can be increased or reduced as necessary. The external-connection electrodes of the microphone unit 1 according to the present embodiment are positioned toward the center in the lengthwise direction both on the top and bottom surfaces of the casing, but the electrodes can also be positioned toward the ends. In addition, the external-connection electrodes can be placed at different positions (for example, toward the center of the top surface and toward the end of the bottom surface) on the top and bottom surfaces of the housing.

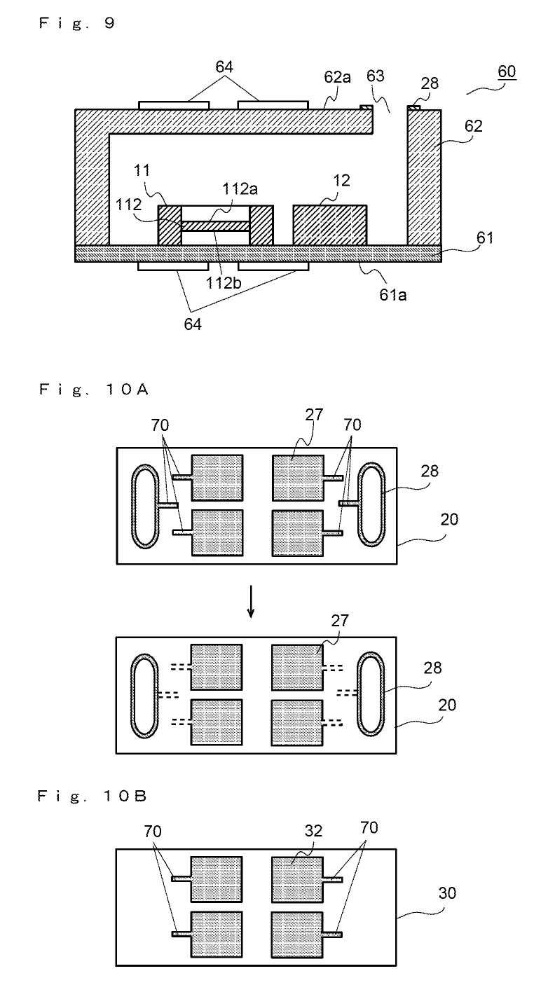

In the embodiment described above, the microphone unit is a differential microphone for converting an acoustic signal to an electrical signal on the basis of a difference in acoustic pressure applied to both surfaces of the diaphragm. However, the present invention is not limited to a differential microphone and can be applied to a microphone unit configured as shown in FIG. 9.

In the microphone unit 60 shown in FIG. 9, the MEMS chip 11 (electro-acoustic converter) and the ASIC 12 are mounted on the top surface of a microphone substrate 61. A cover 62 having an acoustic hole 63 covers the top surface of the microphone substrate 61, and an accommodating space in which the MEMS chip 11 and the ASIC 12 are accommodated is formed. The diaphragm 112 of the MEMS chip 11 is vibrated only by the acoustic waves that pass through the acoustic path leading from the acoustic hole 63 to the top surface 112a of the diaphragm 112 via the accommodating space, and no acoustic waves are incident from the bottom surface 112b of the diaphragm 112.

In the microphone unit 60, an external-connection electrode 64 having the same function is formed on a top surface 62a (back surface on the side of the cover 62 facing the microphone substrate 61) of the cover 62 and on a bottom surface 61a (back surface on the side of the microphone substrate 61 facing the cover 62) of the microphone substrate 61. In addition, a solderable solder junction part 28 is formed so as to enclose the acoustic hole 63 on the top surface 62a of the cover 62. The microphone unit can thus be adapted to be mounted on the top surface of the mounting substrate of a voice input apparatus, or on the bottom surface of the mounting substrate in the same manner as the microphone unit 1 described above. Specifically, the cost of producing a microphone unit can be reduced because a microphone unit that is equivalent to two different types of microphone units is produced by producing the microphone unit 60.

In a case in which, for example, the microphone unit 1 is mounted in a portable telephone or other voice input apparatus in accordance with the embodiment described above, an external-connection electrode on the unused side may come into contact with other parts inside the voice input apparatus, creating a short circuit and causing damage or malfunctioning in these parts. In addition, static electricity may enter an external-connection electrode on the unused side, and the ASIC 12 or other internal circuit may be damaged or caused to malfunction. The following configuration can be adapted to prevent such situations.

Specifically, it is possible to adopt a configuration in which the external-connection electrodes on the unused side are covered by an electrically non-conductive insulating material at a stage at which it is determined whether to mount the microphone unit 1 on the top or bottom surface of the mounting substrate, for example. For example, a resist, an insulating tape (made of epoxy, polyimide, or another resin), or the like can be used for the insulation. In the case in which the external-connection electrode 27 on the top surface of the microphone unit 1 is the electrode on the unused side, the solder junction part 28 is preferably covered by an insulating material as well.

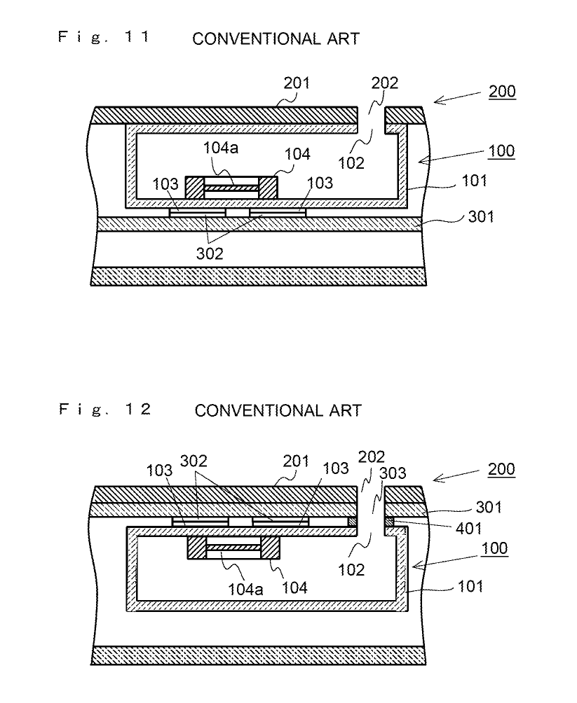

For example, a configuration in which a disconnector 70 is provided to at least a portion of the wiring for electrically connecting the external-connection electrodes 27 and 32 and the ASIC 12, as shown in FIGS. 10A and 10B, can be used as another configuration for preventing the above-mentioned situation. Configuring the microphone unit 1 in such a manner allows the electrical connection between the external-connection electrodes (including the solder junction part 28 in FIG. 10A) on the unused side and the ASIC 12 to be interrupted in a simple manner at a stage in which it is determined whether to mount the microphone unit 1 on the top or bottom surface of the mounting substrate. Examples of methods in which the connection is interrupted using disconnector 70 include laser cutting and routing.

FIG. 10A is a schematic plan view from a downward perspective of the microphone unit 1 provided with the disconnector 70, and FIG. 10B is a schematic plan view from an upward perspective of the microphone unit 1 provided with a disconnector 70. To facilitate understanding, the bottom of FIG. 10A shows a state in which the components are disconnected using the disconnector 70.

In the above-described embodiment, the MEMS chip 11 and ASIC 12 are configured as separate chips, but the integrated circuit mounted on the ASIC 12 may also be formed monolithically on the silicon substrate that forms the MEMS chip 11.

In the above-described embodiment, the electro-acoustic converter for converting acoustic pressure to an electric signal is an MEMS chip 11 formed using semiconductor production technology, but the electro-acoustic converter is not necessarily restricted to this configuration. For example, the electro-acoustic converter can also be a capacitive microphone or other microphone that uses an electret film.

In the above-described embodiment, a so-called capacitive microphone is adopted as the configuration of the electro-acoustic converter (corresponds to the MEMS chip 11 of the present embodiment) provided to the microphone unit. However, the present invention can also be applied to a microphone unit in which a configuration other than a capacitive microphone is adopted. For example, the present invention can be applied to a microphone unit in which a dynamic, magnetic, piezoelectric, or other microphone is adopted.

In addition, the shape of the microphone unit is not necessarily restricted to the shape of the present embodiment and can of course be modified to a variety of shapes.

The microphone unit of the present invention can be used, for example, in portable telephones, transceivers, and other types of voice transmission equipment, as well as voice processing systems that use technology for analyzing an input voice (voice identification systems, voice recognition systems, command-generating systems, electronic dictionaries, translation machines, voice-input remote controllers, and the like), recording equipment, amplifier systems (megaphones), microphone systems, and the like.

What is claimed is:

1. A microphone unit comprising:
an electro-acoustic converter for converting an acoustic signal to an electric signal, the converter having a diaphragm displaced by acoustic pressure; and
a housing provided with an accommodation space for accommodating the electro-acoustic converter, and with an acoustic path for guiding outside sound from an acoustic hole to the diaphragm;
wherein
an external-connection electrode having the same function is formed on a first external surface belonging to the housing and having the acoustic hole, and on a second external surface on the side opposite the first external surface of the housing.

2. The microphone unit according to claim 1, wherein:
the housing has a substrate for mounting the electro-acoustic converter, and a cover for covering the substrate to form the accommodation space, the cover having the acoustic hole;
the first external surface is a back surface on the side of the cover facing the substrate; and
the second external surface is a back surface on the side of the substrate covered by the cover.

3. The microphone unit according to claim 1, wherein:
the acoustic hole includes a first acoustic hole and a second acoustic hole;
the housing includes a substrate for mounting the electro-acoustic converter, a cover having a first space communicating with the first acoustic hole and a second space communicating with the second acoustic hole, the cover covering the substrate so that the first space forms the accommodation space, and a groove-forming member disposed on a side of the substrate opposite the side where the cover is disposed, the member forming a groove;
the substrate has a first through-hole provided so as to face the diaphragm and a second through-hole provided separately from the first through-hole;
the acoustic path includes a first acoustic path leading from the first acoustic hole to one surface of the diaphragm via the accommodation space, and a second acoustic path leading from the second acoustic hole to the other surface of the diaphragm via the second space, the second through-hole, the groove, and the first through-hole in succession;
the first external surface is a back surface on the side of the cover facing the substrate; and
the second external surface is a back surface on the side of the groove-forming member facing the substrate.

4. The microphone unit according to claim 1, wherein:
a solderable junction part is formed so as to enclose the acoustic hole in the first external surface.

5. The microphone unit of claim 1, comprising:
a disconnector for interrupting an electrical connection of the external-connection electrode on the unused side.

6. The microphone unit according to claim 2, wherein:
the cover and the substrate are formed from the same material.

7. The microphone unit according to claim 2, wherein:
a solderable junction part is formed so as to enclose the acoustic hole in the first external surface.

8. The microphone unit according to claim 2, comprising:
a disconnector for interrupting an electrical connection of the external-connection electrode on the unused side.

9. The microphone unit according to claim 3, wherein:
the cover and the substrate are formed from the same material.

10. The microphone unit according to claim 3, wherein:
a solderable junction part is formed so as to enclose the acoustic hole in the first external surface.

11. The microphone unit according to claim 3, comprising:
a disconnector for interrupting an electrical connection of the external-connection electrode on the unused side.

12. The microphone unit according to claim 4, comprising:
a disconnector for interrupting an electrical connection of the external-connection electrode on the unused side.
